(19) United States
(12) Patent Application Publication
(10) Pub. No.: US 2020/0198660 A1
(43) Pub. Date: Jun. 25, 2020

(54) Road Vehicle and Method for Reengaging Manual Driving

(71) Applicant: Institut Français de Sciences et Technologies des Transports, de I'Aménagement et des Réseaux, Champs-sur-Marne (FR)

(72) Inventor: Thierry Bellet, Lyon (FR)

(21) Appl. No.: 16/629,411

(22) PCT Filed: Jul. 10, 2018
(86) PCT No.: PCT/EP2018/068686

§ 371 Date: Jan. 8, 2020

(30) Foreign Application Priority Data
Jul. 11, 2017 (FR) 1756574

(51) Int. Cl. B60W 60/00; B60R 1/00; B60K 35/00; B60W 50/14; G06K 9/00

(52) U.S. Cl. CPC B60W 60/0053; B60W 2050/146; B60K 35/00; B60W 50/14; G06K 9/00798; G06K 9/00825; G06K 9/00805; B60R 2300/10; B60R 2300/20; B60R 2300/804; B60R 2300/8093; B60K 2370/175; B60K 2370/177; B60K 2370/1876; B60K 2370/31; B60R 1/00

(57) ABSTRACT

A road vehicle including a transmitter of a real image of an exterior environment of the road vehicle, and a driving assistant including an assistance display, a driving automaton, and a mask able to evolve between a masking configuration and a non-masking configuration, the driving assistant toggling between a manual mode and an automatic mode of the driving automaton and being configured to implement a phase of reengagement of the manual mode, including a first time period, throughout all of which the mask is maintained in the masking configuration, the assistance display broadcasting a symbolic representation of the exterior environment, and a second time period throughout all of which the mask is maintained in the non-masking configuration.

### CROSS-REFERENCE TO RELATED APPLICATIONS

This application claims benefit under 35 USC § 371 of PCT Application No. PCT/EP2018/068686 entitled ROAD VEHICLE AND METHOD FOR REENGAGING MANUAL DRIVING, filed on Jul. 10, 2018 by inventor Thierry Bellet. PCT Application No. PCT/EP2018/068686 claims priority of French Patent Application No. 17 56574, filed on Jul. 11, 2016.

### FIELD OF THE INVENTION

The present invention relates to a road vehicle and a method for reengaging manual driving implemented using such a road vehicle.

The invention relates to the field of road vehicles, in particular of the automobile, bus, truck or two-wheeled type, preferably for civilian or professional use. Preferably, the invention does not relate to military applications.

### BACKGROUND OF THE INVENTION

Technical progress is encouraging the development of road vehicles capable of being partially or fully autonomous in maneuvering or traffic situations on a road system. In the case where a vehicle of this type is able to travel under the full control of an automatic controller, the driver person may temporarily give up the capacity of driver and simply become a passenger while the automatic controller drives the vehicle.

Some situations may require a disengagement of the automatic controller from driving of the vehicle, and a simultaneous reengagement of the driver person to take over driving of the vehicle. This may involve emergency situations, situations in which the implementation of the automatic controller is less appropriate, less effective or less safe than that of the driver person, or situations in which it is necessary to call on a decision from the driver person, for example what direction the road vehicle should go.

An abrupt passage from automatic driving mode to manual driving mode could prove dangerous, inasmuch as the driver person, fully trusting automatic driving, pays less attention and is less aware of the exterior environment of the vehicle, relative to a situation in which the same driver person would be responsible for driving the vehicle.

### SUMMARY OF THE DESCRIPTION

It has thus been considered to provide, immediately before toggling to manual driving, a phase for reengagement of the driving during several seconds, in which the driver person is notified by a signal that he must prepare to take over driving.

However, as a function of the people subject to this reengagement phase, the concentration time and time for re-appropriation of the exterior environment of the vehicle can vary in length. Additionally, there is a risk that the driver person will resume manual driving based on incorrect information related to an incorrect perception, or an inaccurate prejudgment of the situation built before resuming manual driving.

As a result, the invention aims to provide a new road vehicle that offers reengagement of a manual driving mode that is particularly safe and brief.

The invention relates to a road vehicle able to transport at least one driver person, the road vehicle comprising:
at least one transmitter of a real image of an exterior environment of the road vehicle to the driver person;
a driving assistant, which comprises:
   at least one assistance display for the driver person;
   a driving automatic controller;
   at least one mask able to evolve between:
      a masking configuration, in which the real image of the transmitter is transmitted masked, or is not transmitted, to the driver person; and
      a non-masking configuration, in which the real image of the transmitter is transmitted non-masked to the driver person;
the driving assistant being configured to toggle between:
   a manual mode in which at least one driving control of the road vehicle is placed under the control of the driver person in order to drive the road vehicle; and
   an automatic mode in which the driving control is placed under the control of the driving automatic controller in order to drive the road vehicle;
the driving assistant being configured to implement a phase of reengagement of the manual mode, immediately before toggling of the driving assistant into manual mode, and while the driving assistant is still in automatic mode, the phase of reengagement comprising:
   a first time period, throughout all of which the mask is maintained in the masking configuration, the assistance display broadcasting a symbolic representation of the exterior environment, to the driver person during at least part of the first time period; and
   a second time period following the first time period and immediately preceding the toggling of the driving assistant from the automatic mode to the manual mode, throughout all of which the mask is maintained in the non-masking configuration.

One idea at the base of the invention is to draw inspiration from the natural working of the human cognitive system when the latter builds a mental representation corresponding to its awareness of the exterior environment of the road vehicle, that is to say, the driving scene, which is preferably a road scene, or can be designated driving scene, in which the road vehicle is located. This involves framing and facilitating this cognitive construction process, by subjecting the driver person, during the phase of reengagement of manual mode, to different visual elements, in particular the masked real image of the exterior environment, the symbolic representation of the exterior environment, then the non-masked real image.

One idea at the base of the invention is, during the phase of reengagement, to have a period of time, at the beginning of the phase of reengagement, during which the perception of the exterior environment by the driver person is reinitialized, by temporary masking of the real image of the environment, based on which the driver person is supposed to build his perception of the exterior environment. In other words, owing to the masking, the mental perception of the driver person, regarding the exterior environment, is “reset”. This makes it possible, if applicable, to remove any inaccurate prejudice from the mind of the driver person, or any imperfect pre-existing mental representation, regarding the exterior environment of the vehicle, without which any resumption of manual driving could lead the driver person, based on this inaccurate prejudice or this imperfect representation, to make an inappropriate or even dangerous decision for the driving of the road vehicle. This first period of time also ensures that, irrespective of the driver person and his ability to avoid forming inaccurate prejudices in his mind, the continuation of the phase of reengagement has begun on a same mental representation basis.

Another idea at the base of the invention is to provide the driver person, for at least part of this first period, with the symbolic representation of the exterior environment, which is advantageously a simplified and/or codified representation using symbols, allowing the person to understand the exterior environment easily in order to build his mental representation. This symbolic representation advantageously shows the person, preferably in a certain order and according to a certain predetermined rhythm, in turn, progressively or cumulatively, certain essential elements of this exterior environment, such as a system of paths or objects of special attention of this exterior environment. It is thus particularly easy for the person to build his mental representation by gradually becoming aware of all of the elements of the exterior environment of the road vehicle, which prevents any error in judgment when the manual mode is triggered again.

Another idea at the base of the invention is to anticipate the second period of time, in which, once an accurate mental representation of the essential elements of the exterior environment has been built by the driver person during the first period, this driver person is faced with the exterior environment as it really is, in order to complete this mental representation so as to enter manual mode.

Other optional and advantageous features of the invention are defined hereinafter:
The driving assistant is configured so that the phase of reengagement lasts between 1 and 30 seconds, preferably between 2 and 7 seconds.
When the exterior environment comprises a system of road traffic lanes in which the road vehicle is positioned; and at least one object of attention, which is present on the system of road traffic lanes and is chosen among: a third-party road vehicle, a person, an animal, an obstacle, and a signaling element of the road traffic belonging to the road traffic lane system; the driving assistant is configured such that the first time period comprises: a first subperiod, during which the symbolic representation does not represent the system of road traffic lanes or the object of attention, or is not broadcast; and a second subperiod, following the first subperiod, during which the symbolic representation represents the system of road traffic lanes without representing the object of attention.
The driving assistant is configured such that the first time period comprises a third subperiod, following the second subperiod, during which the symbolic representation represents both the system of road traffic lanes and the object of attention.
When the exterior environment comprises at least two objects of attention, including a first object of attention and a second object of attention, the driving assistant is configured so that during the third subperiod, the symbolic representation represents both the system of road traffic lanes and the first object of attention without representing the second object of attention, and the first time period comprises a fourth subperiod following the third subperiod, during which the symbolic representation simultaneously represents the system of road traffic lanes, the first object of attention and the second object of attention.
The driving assistant is configured such that the second time period comprises a fifth subperiod during which the assistance display continues to broadcast the symbolic representation.
During the phase of reengagement, at least during the second time period, the assistance display is configured to superimpose, to the attention of the driver person, in the background, the real image supplied by the transmitter, and in the foreground, the symbolic representation.
The driving assistant is configured so that each subperiod lasts between 0.4 seconds and 2 seconds, preferably between 0.5 seconds and 0.8 seconds.
The driving control of the road vehicle comprises at least one of the following controls: a steering management control of the road vehicle, an acceleration control of the road vehicle, and a deceleration control of the road vehicle.

The invention also relates to a method for reengagement of manual driving, implemented using a road vehicle according to the preceding, in which method, before toggling the driving assistant from the automatic mode to the manual mode, the driving assistant implements a reengagement phase.

### BRIEF DESCRIPTION OF THE DRAWINGS

The invention will be better understood upon reading the following description, provided solely as a non-limiting example and done in reference to the drawings, in which:

FIGS. 1 to 6 each show a road vehicle according to one preferred embodiment of the invention, from the perspective of a driver person on board this road vehicle, and

FIG. 7 is a block diagram illustration of the road vehicle of FIGS. 1 to 6.

### DETAILED DESCRIPTION

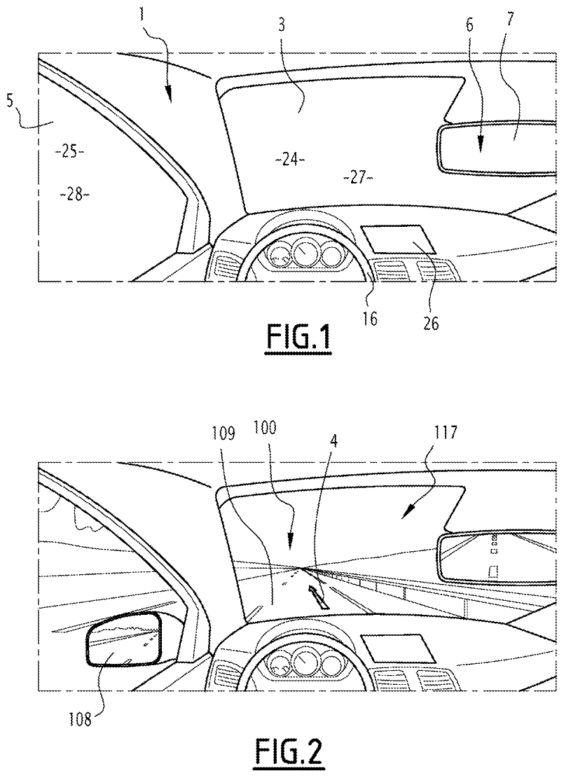

The road vehicle 1 illustrated in FIGS. 1 to 6 is an automobile. The road vehicle could also be a truck, a bus, a coach bus, a two-wheeled vehicle, or any other type of road vehicle. The road vehicle 1 is preferably motorized. The road vehicle 1 preferably has at least two driving wheels actuated by the motor means.

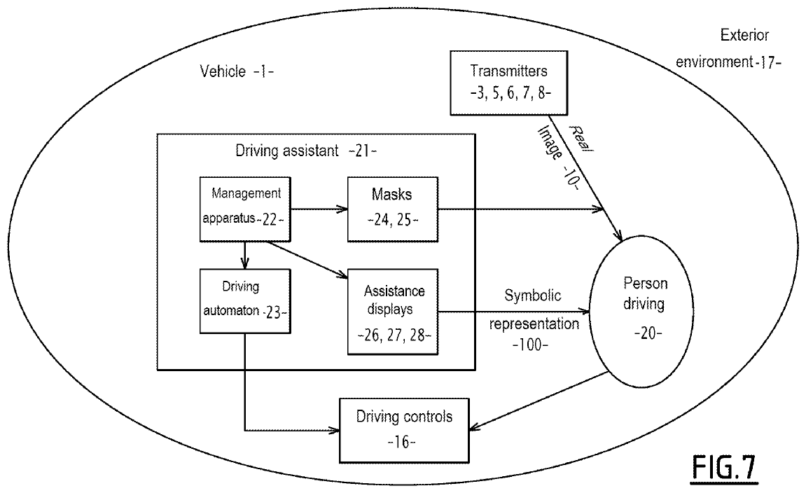

The vehicle 1 is provided to transport a driver person 20, symbolized by FIG. 7 and not visible in FIGS. 1 to 6. When he is transported, the person 20 is for example in the seated position in a driver's station comprising a front left seat of the vehicle 1. In general, the driver person 20 is located in the passenger compartment. A driver person 20 for example refers to a person designated as responsible for the driving of the vehicle, able to drive the vehicle himself through action on the driving controls of the vehicle 1, in certain situations described hereinafter. Optionally, the road vehicle 1 can transport other people or animals, or passengers, and/or objects such as items or merchandise.

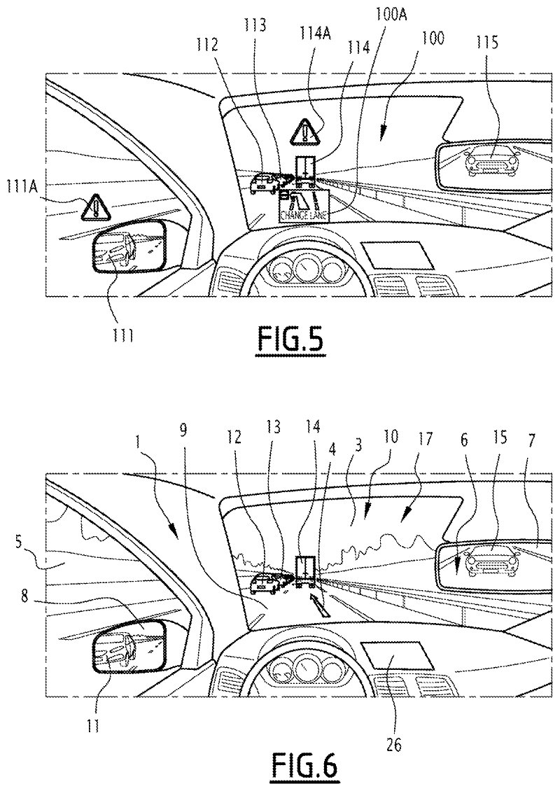

As visible in FIG. 6, the vehicle 1 is provided with a windshield 3, side windows, of which only a front left side window 5 is visible in FIG. 6, a central interior rearview mirror 7, a rear window 6, which is visible by reflection in the rearview mirror 7 in FIG. 6, exterior side view mirrors, a left exterior side view mirror 8 of which is visible in FIG. 6. Each of these elements constitutes a transmitter of a real image 10 of an exterior environment 17 of the vehicle to the attention of the driver person 20, this real image 10 being visible in a non-masked manner in FIG. 6. Indeed, if he so wishes, the driver person 20 can pay attention to the exterior environment 17 through each of these transmitters, and thus observe and detect information regarding this exterior environment 17. A visor of a headset worn by the driver person 20, a pair of glasses worn by the driver person 20 can also constitute such a transmitter. In a variant, a window without glass or an open window of the vehicle can also constitute such a transmitter. In general, the transmitter preferably comprises at least one window, a mirror or a lens through which the driver person 20 can observe a real image 10 of the exterior environment 17 of the vehicle 1, that is to say, an image transmitted by an optical means of the exterior environment 17 as it is in reality, at the moment where this observation takes place.

In a variant, the transmitter, or at least one of the transmitters, comprises a sensor of the real image 10, such as a camera, as well as a means for retransmitting the real image 10 thus detected, such as a display provided with a monitor that displays the real image 10 detected by the camera, to the attention of the driver person 20. This transmission means can be one of the assistance displays of the vehicle, such as the assistance displays 26, 27 and 28 described hereinafter. Alternatively, the retransmission means comprises a real image display 10 belonging to the road vehicle and separate from the assistance display.

“Exterior environment” refers to the environment located in the vicinity of the vehicle 1, at least part of which is in the field of view of the driver person 20 via the transmitter(s). Preferably, exterior environment 17 refers to a part of the environment that is limited to what may affect the vehicle 1 imminently, and/or part of the surroundings of the vehicle, for example located at less than 300 meters in radius from the vehicle 1.

At least on a primary basis, the vehicle 1 is provided to be parked, stopped, maneuvered and driven on a road system, in particular comprising roads that are paved or covered with materials favorable to road traffic, and thus forming a system of road traffic lanes. In the present example, the system of traffic lanes comprises a main paved road segment 9, on which the road vehicle 1 is positioned and travels in the direction 4, which is a forward direction. At least part of the system of traffic lanes, in particular the road segment 9, belongs to the exterior environment 17 of the vehicle 1.

The exterior environment 17 may also comprise, as shown in FIG. 6, third-party road vehicles, such as the vehicles 11, 12, 13, 14 and 15, belonging, in this scenario, to the road traffic traveling on the road segment 9 and being separate from the vehicle 1. These vehicles 11, 12, 13, 14 and 15 may constitute a constraint for the driving of the road vehicle 1. For example, the vehicle 14 progressing in front of the vehicle 1 along a same trajectory may force the vehicle 1 to decelerate or brake in order to avoid a collision, if the vehicle 14 is at a slower speed than the vehicle 1 or slows down. The vehicles 11, 12 and 13 circulating along a trajectory parallel to, and to the left of, that of the vehicle 1, they may oppose a change of trajectory to the left by the vehicle 1. The vehicle 15 being behind the vehicle 1, it may oppose too great a deceleration by the vehicle 1. In general, the vehicles 11, 12, 13, 14 and 15 being able to conflict with or constrain the driving of the vehicle 1 in order to avoid a collision, they constitute objects of attention in the exterior environment 17 of the vehicle 1. The exterior environment 17 could also comprise other objects of attention, such as people, animals, obstacles present on the segment 9, which could similarly impact the driving of the vehicle 1, or a signaling element for the road traffic, for example indicating a speed limit, a destination indication, an obligation to stop, or any other traffic rule on the segment 9.

The vehicle 1 also comprises a steering wheel 16 visible in FIGS. 1 to 6, as well as an accelerator pedal, a brake pedal, as well as optionally any other appropriate driving control of the vehicle 1. As opposed to an auxiliary control of the vehicle, for example including control of the air conditioning, opening of a door, a driving control preferably refers to a control that produces a substantial effect on the behavior of the vehicle within the exterior environment 17. For example, this may involve a control for managing the direction of the road vehicle 1, accelerating the road vehicle, and/or decelerating the road vehicle, for example by braking.

As illustrated in FIG. 7, the road vehicle 1 comprises a driving assistant 21, which is made up of an apparatus or a system of apparatuses embedded in the vehicle 1.

Preferably, the driving assistant 21 comprises a management apparatus or module 22, able to coordinate the operation of its other component elements. This apparatus 22 preferably comprises a processor and a memory, for example assuming the form of an embedded computer, or an electronic apparatus, for executing a program in order to ensure the management and coordination of the other elements of the driving assistant 21.

The assistant 21 also comprises a driving automatic controller 23. Owing to this driving automatic controller 23, the assistant 21 is able to be toggled, on command by the person 20 or on command by the driving module 22, between:
a manual mode in which the driving controls 16, preferably the steering management and acceleration and deceleration controls, are placed under the control of the person 20 in order to drive the vehicle 1;
an automatic mode in which these controls are placed under the control of the driving automatic controller 23 in order to drive the vehicle.

Preferably, in automatic mode, at least one of the driving controls, or even all of them, are under the control of the automatic controller 23 without intervention by the person 20. Preferably, in automatic mode, the automatic controller 23 provides autonomous driving of the vehicle 1. Alternatively, at least one of the driving controls is under the control of the automatic controller 23 with a possibility of intervention, decision, instruction or correction of the management of this control by the person 20.

It is preferred for the automatic driving mode to be a highly automated driving mode, which transmits the responsibility for driving of the vehicle to the driving automatic controller, while the driver person is released therefrom.

Preferably, in manual mode, at least one of the driving controls, or even all of them, are under the control of the person 20 driving with assistance or aid by the automatic controller 23 or another component of the vehicle 1. Alternatively, at least one of these controls is fully under the control of the person 20 without assistance.

The automatic controller 23 can assume the form of an apparatus or module, separate or combined with the apparatus 22, and for example comprising a processor and a memory that are configured to execute a program for automating the driving of the vehicle 1. The automatic controller 23 and the apparatus 22 for example communicate using a data bus or any equivalent wired or wireless means. The driving assistant 21 preferably comprises various sensors provided on the vehicle 1, in order to send the automatic controller 23 any information necessary for the automatic driving, in particular information regarding the exterior environment 17 and various parameters of the vehicle 1. Optionally, the automatic controller 23 can comprise a wireless receiver of driving instructions sent remotely by a remote driving manager, by road infrastructure, and/or by the other vehicles.

In automatic mode and manual mode, the driving can in particular consist of parking, stopping, low-speed maneuvering, or driving at cruising speed, of the vehicle 1.

As illustrated in FIGS. 1 and 7, the assistant 21 also comprises one or several masks 24 and 25. Each mask 24 and 25 is associated with at least one of the transmitters 3, 5, 6, 7 and 8. In the present example, the mask 24 is a mask of the windshield 3, and the mask 25 is a mask of the side window 5. Each mask of the vehicle 1 is able to evolve between:
a masking configuration, like in FIGS. 1 to 5, in which the real image 10 of the transmitter associated with the mask in question is transmitted, masked, to the attention of the person 20; and
a non-masking configuration, as illustrated in FIG. 6, in which the real image 10 of the transmitter associated with the mask in question is transmitted, non-masked, to the attention of the person 20.

Each mask 24 and 25 is for example formed by a mechanical device, such as a motorized blind, commanded by the apparatus 22, so as to evolve between the masking configuration in which the blind at least partially covers the windshield 3 and the window 5, respectively. The same scheme can optionally be applied to the rearview mirrors 7 and 8, the rear window, and any other transmitter of the vehicle 1, in particular in the case where this transmitter comprises a window through which the person 20 may wish to observe the environment 17. It is also possible to provide that the transmitter and the mask form a single device or a single system.

For example, a windshield with opacification commanded by the apparatus 22 can be provided and perform both a transmitter and mask function. Such a device evolves between a masking configuration, in which it is opaque, darkened or blurred, and a non-masked configuration, in which it is relatively translucent. For this commanded opacification of a window, it is for example possible to provide a pigmentation, or a chemical element, able to be commanded under the effect of an electrical impulse by the apparatus 22.

In the case where the transmitter comprises a sensor and a retransmission means, the mask may consist of cutting off the retransmission, cutting off the sensor or any similar means. Also in this case, the transmitter may embed the mask function.

Irrespective of the embodiment, as a function of the application, in the masking configuration, the mask may in particular, in the masking configuration, conceal, darken or blur the real image 10 transmitted to the attention of the driver person. The masking configuration may consist of a non-transmission of the real image 10 to the person 20. In any case, the masking configuration makes the grasp of the environment 17 difficult by the person 20, such that the latter cannot normally grasp the environment 17 sufficiently for manual driving of the vehicle 1 at that moment, even with a certain observation time.

In the non-masking configuration, the real image 10 is submitted to the attention of the person 20 in a less concealed, less blurred or less darkened manner, in any case so as to allow the person 20 to grasp the environment 17 sufficiently for manual driving of the vehicle 1, at least after a certain observation time.

The assistant 21 also comprises one or several driving assistance displays. The display supplied by each assistance display is to the attention of the person 20. Each assistance display is advantageously configured to communicate with the driving apparatus 22.

Each assistance display may assume the form of a remote display 26, provided for example as an element of the dashboard, or fastened on the windshield. The display 26 may also be a removable or moving peripheral, able to communicate with the management apparatus 22 with or without a wired connection, and being able to be manipulated by the person 20. The assistance display can be worn by the driver person, in the form of a headset or the like. In this case, the assistance display comprises at least one display monitor of an image. If it constitutes a removable or moving peripheral, it may for example assume the form of an electronic tablet. Such a remote display may optionally perform, in addition to its assistance display function, a transmitter function for the real image 10 of the environment 17, and a mask function. This display may therefore assume the form of an augmented reality and/or virtual reality display.

Each assistance display may assume the form of a display integrated into, or combined with, one of the transmitters, for example a display or an augmented reality display. All or some of the transmitters can be equipped therewith, depending on the application. In the illustrated example, several transmitters of the vehicle 1 are equipped with an assistance display: the windshield 3 comprises a display 27, the side window 5 comprises a display 28, and the rear window 6 and/or the central rearview mirror 7 comprises a display. Each of the aforementioned windows therefore for example comprises a transparent screen, the transparency of which can be concealed for all or part of the window surface, to display an artificial image on this surface, as opposed to the real image 10 transmitted by this screen when it is transparent. In this case, the display can also perform the mask function, such that a same display of the vehicle 1 can simultaneously perform the transmitter, mask and assistance display functions. Each of the aforementioned windows alternatively comprises a head-up display, which makes it possible to superimpose an artificial image on top of the real image 10. In this case, a same device does not necessarily perform the mask function, but simply the transmitter and assistance display functions.

The assistance display can also assume the form of a head-up display that is remote or separate from the transmitters of the vehicle 1.

All or some of the aforementioned assistance displays are known to broadcast, that is to say, to submit a symbolic representation 100 of the environment 17 to the attention of the person 20.

The symbolic representation 100 preferably consists of an artificial representation of the environment 17, for example in a form that is drawn and/or stylized and/or graphic and/or enhanced with icons and/or comprising certain selected parts of the real image 10, presented in fragmented, grouped and/or transformed form. The symbolic representation 100 may in particular represent only certain objects of attention from the environment 17, as defined above. Preferably, at least one of the representations of an object of attention is accompanied by or associated with the representation of an icon. The symbolic representation 100 is in particular a simplified representation of the reality of the environment 17, illustrated from the point of view of the person 20. In other words, the symbolic representation 100 is preferably a perspective view from an angle identical or close to that of the real image 10 perceived by the person 20, like a simulation of the reality of the environment 17. The symbolic representation 100 is advantageously three-dimensional, but can be shown in two-dimensional form, for example in the form of a bird's-eye view, describing the environment 17. The symbolic representation 100 advantageously illustrates the environment 17 in its present state, preferably in a dynamic and animated manner. The symbolic representation 100 can illustrate the environment 17 can contain indications regarding the environment 17 in a past state or an anticipated or estimated future state.

All or some of the aforementioned assistance displays, in particular the displays 27 and 28, are preferably configured to broadcast, to the person 20, a superposition of the real image 10, which may or may not be masked, and the symbolic representation 100 of the aforementioned environment 17. “Superposition” means that, from the perspective of the driver person, the elements symbolically represented by the symbolic representation 100 are positioned at a same coordinate, or a neighboring coordinate, of the field of view of the driver person, that the real elements appear in the real image 10 in the background of the symbolic representation 100, matching the position in the image. This is the case in a head-up display and in an augmented reality display. Preferably, in this superposition, the real image 10 supplied by the transmitter is in the background while the symbolic representation 100 is in the foreground.

Alternatively, an assistance display can transmit only the symbolic representation 100, without superposition with the real image 10.

In the present example, as illustrated in FIGS. 2 to 5, the displays 26, 27 and 28 display, within the symbolic representation 100:
a symbolic representation 117 of at least part of the environment 17;
a symbolic representation 109 of the segment 9;
a symbolic representation 108 of the rearview mirror 8, or of any other element of the vehicle 1 whose real image 10 would be visible by the person 20 using one of the transmitters;
a respective symbolic representation 111, 112, 113, 114 and 115 of third-party vehicles 11, 12, 13, 14 and 15, two of which are associated with an icon 111A and 114A, in order to draw the attention of the person 20 to the vehicles 11 and 12, or to provide information about these vehicles 11 and 12.

In the present example, the representation of the segment 9 is symbolic inasmuch as many details of the exterior environment that are not essential to the driving have been simplified: in particular, the trees and the clouds in the sky have been eliminated.

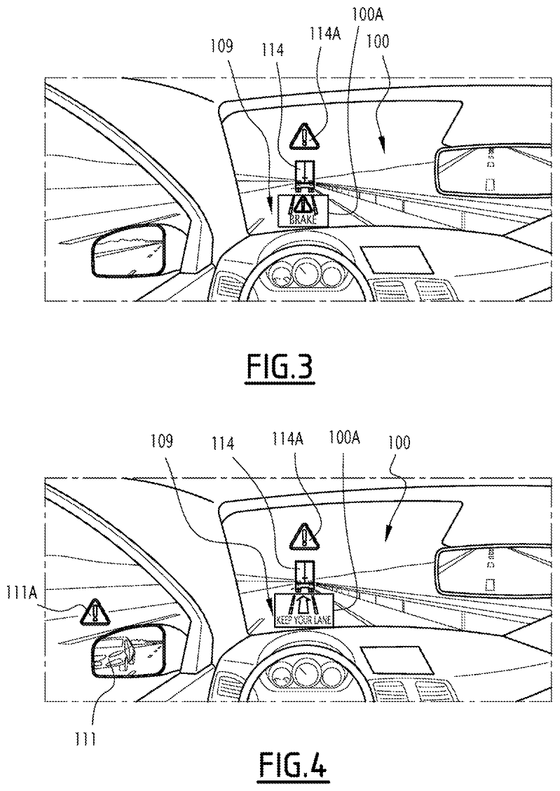

The icons can simply draw the attention of the person 20 to one of the objects of attention, or additionally, present information regarding characteristics of the object of attention, for example its speed if it is a vehicle, or a direction associated with one of the lanes of the road segment 9. The icons can also represent, symbolically and/or in writing, mandatory, recommended, advised, possible, discouraged, impossible and/or prohibited driving actions, that the person 20 may engage when he resumes control of the vehicle 1 in manual mode. For example, the icon 100A of FIG. 3 indicates that one should brake, in order to avoid a collision with the vehicle 14. For example, in FIG. 4, the icon 100B indicates that one should keep the vehicle 1 in the same lane. The icon 100C in FIG. 5 indicates that one should not move the vehicle 1 into the left lane, in order to avoid a collision in particular with the vehicle 11 traveling in this left lane. Another icon could indicate a possibility of changing lanes, accelerating, or recalling the path to be followed to continue a given itinerary. The symbolic representation 100 may also contain a representation of certain information specific to the state or characteristics of the vehicle. For example, the representation 100 may indicate that the driving assistant 21 is in automatic mode and that it is preparing to toggle to manual mode, while indicating the time remaining before this toggle to manual mode. The representation 100 may also contain an indication of the remaining fuel, the speed of the vehicle, the temperature of certain parts of the engine system of the vehicle, or any other information that is useful at the given moment.

The vehicle 1 thus defined, and more particularly the driving assistant 21, is configured to implement a method for reengaging manual driving, comprising a phase for reengaging manual mode, immediately before toggling to manual mode, for example ordered by the person 20 or the management apparatus 22. This reengagement phase is implemented while the automatic mode is still engaged, and ends upon toggling to manual mode. It is preferred for this reengagement phase to be implemented before any toggling to manual mode of the assistant 21.

Preferably, in automatic driving mode, in particular immediately before the reengagement phase, the person 20 is at the driving station of the road vehicle 1, or at least is on board the road vehicle 1, so as to be able to pay attention to the real images and the symbolic representations that may be submitted to him. In automatic driving mode, in particular immediately before the reengagement phase, the mask is kept in the non-masking configuration, such that the person 20 receives the non-masked real image and can see the exterior environment of the road vehicle.

Preferably, at least during the reengagement phase, the person 20 is at the driving station of the road vehicle 1, or at least is on board the road vehicle 1, so as to be able to pay attention to the real images and the symbolic representations that may be submitted to him during this reengagement phase.

Preferably, the reengagement phase lasts between 1 and 30 seconds, preferably between 2 and 7 seconds, which normally leaves enough time for the person 20 to rebuild a mental representation for himself of the environment 17 before toggling to manual mode.

The reengagement phase comprises an initial time period, illustrated in FIGS. 1 to 5, which are sorted in chronological order, during all of which the masks 24 and 25 are kept in the masking configuration.

According to one embodiment, at the beginning of this initial time period A, the perception of the exterior environment by the person 20 is reinitialized, as explained above. Preferably, the assistant is advantageously configured such that the first time period comprises a reinitialization subperiod AA, during which the symbolic representation does not represent the system of lanes or the objects of attention, as illustrated in FIG. 1. This normally makes it possible to obtain a complete reinitialization of the mental representation of the exterior environment 17 by the person 20.

This subperiod AA could alternatively be obtained by simple absence of broadcast of the symbolic representation, the person 20 only receiving the masked real image 10.

During part of the period A preferably beginning as of the end of the subperiod AA and ending at the end of the period A, it is provided that the assistance displays 26, 27 and 28 broadcast the symbolic representation 100, including the symbolic representation 117 of the exterior environment 17 of the vehicle 1, to the attention of the person 20, this situation being illustrated in FIGS. 2 to 5.

This preferably begins with a subperiod AB illustrated in FIG. 2, which takes place immediately following the subperiod AA. During this subperiod AB, the symbolic representation 100 comprises the symbolic representation 109 of the segment 9, or more generally of the system of lanes. The person 20 thus learns a piece of driving context information, which is nevertheless fundamental for manual driving and the reconstruction of his mental representation of the exterior environment 17. In this subperiod AB, no object of attention is represented: in particular, the symbolic representation does not comprise the representations of the vehicles, obstacles or any other element.

Preferably, during the period A, a subperiod AC immediately follows the subperiod AB, during which the representation 114 of the vehicle 14 is added to the representation 109, while the other objects of attention are still not represented, as illustrated in FIG. 3. More generally, during this subperiod AC, the symbolic representation 100 represents both the system of lanes and a first object of attention, without representing the second object of attention. Preferably, the first object of attention is chosen from among the objects of attention of the environment 17 considered to be most critical for the driving of the vehicle 1. “Critical” in particular means any object that may constitute a constraint or an imminent danger without correction of the driving of the vehicle 1. For reasons related to safety or proper driving of the vehicle 1, the attention of the person 20 is advantageously paid as a priority to these critical objects of attention, relative to the other objects of attention that will be shown to the person 20 during the following subperiods. In the illustrated example, the vehicle 14, located in front of the vehicle 1, is in the process of braking, while being in the same lane as the vehicle 1. The vehicle 14 is therefore considered to be critical, since it generates a collision risk between the vehicles 1 and 14 if the driving of the vehicle 1 is not modified quickly according to a deceleration command. Another critical object could be a stationary obstacle placed in the lane of the vehicle 1. Another critical object is in particular an object positioned on the trajectory of the vehicle 1. In a variant, an object of attention may be considered to be critical if it requires immediate decision-making by the person 20 regarding a choice as to whether to change driving, for example the choice of a route or a direction to be followed at an intersection of the road segment 9, but without representing a particular danger.

In the present example, the representation 114 of the critical object is associated with an icon 114A to draw the attention of the person 20 to its critical nature. One can choose to display the icon 114A, optionally combined with an icon indicating a driving action to be taken such as one of the icons 100A, 100B and 100C. In a variant, the icon 114A associated with the critical object is not provided whereas one or several icons are provided indicating a driving action to be taken.

In this subperiod AC, several critical objects of attention can be shown, if they are all considered to be the most critical, and while other objects of attention are not shown.

In another embodiment, it is also possible to consider not performing the subperiod AB, and performing the subperiod AC immediately after the subperiod AA, such that the person 20 receives both the driving context information and the information regarding the critical objects of attention.

According to still another embodiment, the period A begins with the subperiod AB, without subperiod AA. In this embodiment, the assistance displays broadcast symbolic information throughout the entire period A. Preferably, the subperiod AB is immediately followed by the subperiod AC. In this embodiment, the display of the information for the mental reconstruction of the person 20 is done progressively, in a hierarchical manner by order of importance, or prioritized. The objects are not all displayed at the same time, but on the contrary are displayed distributed over time, one by one, or group by group, preferably by order of importance, to allow a good mental reconstruction of the driving situation. Irrespective of the embodiment, immediately following the subperiod AC, during the period A, a subperiod AD is advantageously provided that is illustrated in FIG. 4, during which the symbolic representation 100 simultaneously shows the system of lanes, the critical objects of attention, and one or several other objects of attention that can be described as important, but noncritical objects of attention. “Important” preferably refers to any object that:
does not constitute a danger if the driving of the vehicle 1 is not modified, and is then not critical, and
optionally, does not require an immediate decision to change driving by the person 20, and is then not critical, and
constitutes a danger if the driving of the vehicle 1 is modified inappropriately.

Thus, the person 20 is informed about the constraints conditioning any change in driving that he may wish to undertake during the subperiod AD.

In the case illustrated in FIG. 4, the representation 111 of the vehicle 11 is added to the representation 100, in addition to the representations 109 and 114. The vehicle 11 is in the lane to the left of the vehicle 1, and prevents the vehicle 1 from moving to the left for example to pass the vehicle 14. In this example, the vehicle 11 therefore constitutes an important object of attention, inasmuch as:
without changing the driving of the vehicle 1, there does not appear to be a serious risk of collision between the vehicle 1 and the vehicle 11, and
if the driving of the vehicle 1 is modified by moving to the left, there is a non-negligible risk of collision between the vehicles 1 and 14.

Another critical object could be a stationary obstacle placed in the lane to the left of the lane of the vehicle 1. A critical object is in particular an object positioned outside the current trajectory of the vehicle 1, but on a trajectory that the vehicle 1 could follow, in particular in a driving correction in response to a critical object of attention.

In the present example, the representation 111 of the important object is associated with an icon 111A to draw the attention of the person to its important nature.

The non-important and non-critical objects of attention of the environment 17 are still not shown at the stage of the subperiod AD.

Immediately following the subperiod AD, during the period A, a subperiod AE is advantageously provided that is illustrated in FIG. 5, during which the symbolic representation 100 simultaneously shows the system of lanes, the critical objects of attention, the important objects of attention and all or some of the other non-important and non-critical objects of attention. This subperiod AD constitutes a transitional subperiod prior to the display of the real image 10 done next.

Some of the aforementioned subperiods AA, AB, AC, AD and AE may not be done, the order of the subperiods nevertheless preferably being that set out above. When the environment 17 only contains one object of attention, or no object of attention, or is devoid of critical or important objects, some of the subperiods AA, AB, AC, AD, AE can be extended and/or some subperiods can be eliminated.

Preferably, each subperiod mentioned in the present document lasts between 0.4 seconds and 2 seconds, preferably between 0.5 seconds and 0.8 seconds, which leaves enough time for the person 20 to perform an accurate and precise construction of his own mental representation of the environment 17. Nevertheless, this time is particularly short, in order to allow as quick as possible a resumption of the manual driving by the person 20. Preferably, the period A is paced more or less regularly by these subperiods. Preferably, the duration of each subperiod is the same.

In general, during the period A, the symbolic representation 100 allows a progressive and hierarchical reconstruction of the mental representation, in other words, prioritized. Indeed, the most critical objects are brought to the attention of the person 20 first, while the other objects are presented later. This reproduces a natural process of mental reconstruction of a system by an individual, in order to facilitate this reconstruction.

During the reconstruction phase, a second period B immediately follows the first period A, as illustrated in FIG. 6. The period B extends until the assistant 21 toggles from the automatic mode to the manual mode. The period B begins at the moment where the masks 24 and 25 are placed in the non-masking position by the management apparatus 22. Throughout this entire period B, the masks 24 and 25 are kept in the non-masking configuration by the apparatus 22. During this period B, the person 20 can therefore observe the non-masked real image 10, so that a complete representation of the environment 17 is built in his mind.

Advantageously, the period B comprises a subperiod BA during which at least one of the assistance displays 26, 27, 28 continues to broadcast the symbolic representation 100, at least regarding certain representations such as the icons, and/or certain objects of attention, in particular critical and/or important ones, for example superimposed on the real image 10. This allows an even more progressive transition. In particular, the icons associated with the critical objects, the important objects, and/or indicating a driving action to be taken, are advantageously maintained for several seconds after the transition from masked to non-masked, and optionally after toggling to manual mode. In the eyes of the person 20, these icons preferably appear to be superimposed, that is to say, superimposed on the reality of the exterior environment. As explained above, this is in particular obtained by using head-up viewing devices, or any other augmented reality method.

Optionally, this subperiod BA is followed by a subperiod BB of the period B, in which the symbolic representation is no longer broadcast.

Alternatively, throughout the entire period B, the symbolic representation 100 is broadcast. However, it may be preferable, throughout the entire period B, for the symbolic representation 100 not to be broadcast.

At the end of the period B, the toggle to manual mode is done, and manual driving is resumed by the person 20 with full awareness of the exterior environment 17, the risk of an incorrect manual driving reaction being particularly reduced. Preferably, in manual driving mode, in particular immediately after the reengagement phase, the person 20 is at the driving station of the road vehicle 1, or at least is on board the road vehicle 1, so as to be able to pay attention to the real images and the symbolic representations that may be submitted to him. In manual driving mode, in particular immediately after the reengagement phase, the mask is kept in the non-masking configuration, such that the person 20 receives the non-masked real image and can see the exterior environment of the road vehicle.

In general, the driving assistant 21 can preferably be described as an advanced man-machine interface for the dynamic and progressive reconstruction of the awareness of the exterior environment 17 for the person 20.

1. A road vehicle able to transport at least one driver person, comprising:
at least one transmitter of a real image of an exterior environment of the road vehicle to the driver person; and
a driving assistant comprising:
at least one assistance display for the driver person;
a driving automatic controller; and
at least one mask able to evolve between a masking configuration, in which the real image of said at least one transmitter is transmitted masked, or is not transmitted, to the driver person, and a non-masking configuration, in which the real image of said at least one transmitter is transmitted non-masked to the driver person; person,
wherein the driving assistant is configured to toggle between a manual mode in which at least one driving control of the road vehicle is placed under the control of the driver person in order to drive the road vehicle, and an automatic mode in which the driving control is placed under the control of said driving automatic controller in order to drive the road vehicle, and wherein the driving assistant is configured to implement a phase of reengagement of the manual mode, immediately before toggling of the driving assistant into manual mode, and while the driving assistant is still in automatic mode, the phase of reengagement comprisinq a first time period, throughout which said at least one mask is maintained in the masking configuration, said at least one assistance display broadcasts a symbolic representation of the exterior environment to the driver person during at least part of the first time period, and a second time period following the first time period and immediately preceding the toggling of the driving assistant from the automatic mode to the manual mode, throughout which said at least one mask is maintained in the non-masking configuration.

2. The road vehicle according to claim 1, wherein said driving assistant is configured so that the phase of reengagement lasts between 1 and 30 seconds.

3. The road vehicle according to claim 2, wherein said driving assistant is configured so that the phase of reengagement lasts between 2 and 7 seconds.

4. The road vehicle according to claim 1,
wherein the exterior environment comprises:
a system of road traffic lanes in which the road vehicle is positioned; and
at least one object of attention, which is present on said system of road traffic lanes and is chosen among a third-party road vehicle, a person, an animal, an obstacle, and a signaling element of the road traffic belonging to said system of road traffic lanes;
and wherein said driving assistant is configured such that the first time period comprises a first subperiod, during which the symbolic representation does not represent said system of road traffic lanes or said object of attention, or is not broadcast, and a second subperiod, following the first subperiod, during which the symbolic representation represents said system of road traffic lanes without representing said object of attention.

5. The road vehicle according to claim 4, wherein said driving assistant is configured such that the first time period comprises a third subperiod, following the second subperiod, during which the symbolic representation represents both said system of road traffic lanes and said object of attention.

6. The road vehicle according to claim 5, wherein the exterior environment comprises a first object of attention and a second object of attention, and
wherein said driving assistant is configured so that during the third subperiod, the symbolic representation represents both said system of road traffic lanes and said first object of attention without representing said second object of attention, and the first time period comprises a fourth subperiod following the third subperiod, during which the symbolic representation simultaneously represents said system of road traffic lanes, said first object of attention and said second object of attention.

7. The road vehicle according to claim 1, wherein said driving assistant is configured such that the second time period comprises a fifth subperiod during which said at least one assistance display continues to broadcast the symbolic representation.

8. The road vehicle according to claim 7, wherein, during the phase of reengagement, at least during the second time period, said at least one assistance display is configured to superimpose, to the attention of the driver person: person, in the background, the real image supplied by the said at least one transmitter, and in the foreground, the symbolic representation.

9. The road vehicle according to claim 4, wherein said driving assistant is configured so that each subperiod lasts between 0.4 seconds and 2 seconds.

10. The road vehicle according to claim 9, wherein said driving assistant is configured so that each subperiod lasts between 0.5 seconds and 0.8 seconds.

11. The road vehicle according to claim 1, wherein the driving control of the road vehicle comprises at least one of the following: a steering management control of the road vehicle, an acceleration control of the road vehicle, and a deceleration control of the road vehicle.

12. A method for reengagement of manual driving, implemented using a road vehicle according to claim 1, in which method, before toggling the driving assistant from the automatic mode to the manual mode, the driving assistant implements a reengagement phase.
